(19) United States
(12) Patent Application Publication
(10) Pub. No.: US 2008/0165614 A1
(43) Pub. Date: Jul. 10, 2008

(54) Roller-Type Sprayer-Mixer for Spraying and Mixing Fluids

(76) Inventor: Luigi Pietro Della Casa, Padula Scalo (IT)

Correspondence Address: Luigi Pietro Della Casa, Via Rosaliente no 27, Padula Scalo (SA), I-84030, omitted

(21) Appl. No.: 11/886,706

(22) PCT Filed: Apr. 14, 2005
(86) PCT No.: PCT/IT2005/000215

§ 371 Date: Sep. 19, 2007

(51) Int. Cl. B01F 13/02

(52) U.S. Cl. 366/102

(57) ABSTRACT

The gas and the liquid, to be mixed and interact, enter the atomization chamber (9).

The liquid is immediately atomized by the combs of the seven rollers (1) that rotate in the chamber (9); the particular setting of the 6 rollers (1) in a circle around a central roller (1), thus neutralising the centrifugal forces, guarantees that the liquid fluid (at higher density) does not border the sides of the chamber (9). The gas mixes with the liquid particles, producing foam in which new liquid particles mixed with gas are continuously formed and decomposed. The foam, driven by the pressure above and/or by a screw-type conformation of the combs' rods, drives along the chamber, all the while being mixed and regenerated without the liquid re-compacting and separating from the gas.

### TECHNICAL FIELD

This invention can be included in the category of atomizer, even though its main function is to very rapidly mix continuously flowing fluids. Besides, the use of atomizers is varied. As a matter of fact, they are used for many different purposes (purification, combustion, irrigation, etc.).

### PRE-EXISTING TECHNIQUE

Atomizers that belong to the current state of the art work on the basis of the concept of the atomized liquid, suitably compressed by a pump, being forced through one or more injectors with a limited calibre, which creates resistance to the current. On exiting by the injector, there is a sudden disappearance of the pressure around the liquid, which therefore explodes into micro-aggregates.

### DESCRIPTION

The atomizer-mixer, according to the invention, is made up of:

(1)* Atomizer rollers

(2) Container body

The Atomizer rollers contain:

(3) Axial cylinders

(4) Rods

(5) Disks

The container body contains:

(6) Input tubes

(7) Transmission and input compartment

(8) Collector

(9) Atomization chamber

(10) Support “at rosette”

(11) Windowed support

(12) Sump

(13) Gears

(14) Ball bearings

(15) Transmission joint

* The numbers in brackets correspond with those used in the drawings.

Atomizer Rollers (1):

There have to be a minimum of 7 of these, and their longitudinal axes are parallel to one another. One of these rollers (1) is set up in the centre, while the other six are set up in a circle (reference circle) around the first, at the vertexes of the hexagon inscribed in that circle, and therefore all at the same distance from the centre, which is also the distance between one another. Each roller (1) is represented by a thin axial cylinder (3) on the surface of which there are thin rectilinear rods (4), all perpendicular to the longitudinal axis of the roller.

These rods (4) are aligned along the same straight line for the entire length of the roller, creating a “comb”. For each group of coplanar rods (4); there is a disk (5).

On the upper and lower surfaces, the rods (4) must preferably be serrated with cuts perpendicular to the longitudinal axis of the rod (4), which form thin parallel blades. The depth and number of the cuts must be the largest possible number.

In the 6 peripheral rollers (1):

Especially if they are rigid, the rods (4) must be set up in six longitudinal rows (6 combs) and so as to form six 60° angles on the plane perpendicular to the axis of the roller (1).

At the same height as the rods (4), there is a disk (5) of the same thickness as the rods (4) and with a radius that is shorter than the length of the rods (4). The length of the rods (4) will be obtained by subtracting from the radius of the ideal circle (circle of reference), on which the axial centre of the six external rollers (1) is situated, 18.34% of this measurement plus the radius of the axial cylinder (3) and slightly more than the thickness of a rod (4) (the hypotenuse of a right-angled triangle in which one side is equal to the thickness of a rod and one angle is 30°). The thickness of the rods (4) must be as small as possible; their tips will be rounded.

The radius of the disks (5) must be equal to the radius of the aforementioned circle minus the length of a rod (4) and the radius of the axial cylinder (3); The thickness must be the same as the thickness of the rods (4). (If elastic rods are used, the number of combs used may be even greater).

The peripheral rollers (1) are orientated so that two combs on one roller (1) correspond to the centre of the angle created by two adjacent combs of the two adjacent rollers (1) (see FIG. 4).

The distance between one rod (4) and the one that follows it along the roller (1) will be slightly larger than the thickness of a rod (4), so that one rod (4) can fit through the narrow space in question but without friction.

By taking these measures, the rollers (1) will be able to rotate without the combs touching one another.

In the central roller (1):

There are also rods (4) and disks (5): the length of the rods (4) corresponds to the radius of the “reference circle” minus the diameter of the axial cylinders (3) and enough to avoid contact with the peripheral rollers (1), the thickness will be the same as the thickness of the rods (4) on the peripheral rollers (1). The radius of the disks (5) will be the same as the radius of the disks (53 on the peripheral rollers (1). Their thickness will be the same or smaller. The rods (4) and the disks (5), unlike on the peripheral rollers (1), alternate longitudinally along the axis of the roller (1).

The rods (4) will be set up along the longitudinal axis so as to match the spaces between the rods (4) on the peripheral rollers (1), through which they must be able to pass without touching.

The disks (5) will be coplanar with the rods (4) (and with the disks) on the peripheral rollers (1).

There will be 6 combs on the central roller (1) (when using elastic material, as in the case of the peripheral rollers, there may be a greater number).

If necessary, it is possible, as an auxiliary measure or alternatively to the propulsion of the fluids external to the atomizer, to incline the rods (4) on the peripheral and central rollers (1), making them rotate suitably around their longitudinal axis.

In this case, the rods (4) must be made with laminar shape. This set up creates a series of propeller on successive planes, which produce, not only the atomization, but also a driving force for the atomized mixture.

Evidently on the horizontal plane, perpendicular to the axis of the rollers (1), the position of the rods (4) on one roller (1) towards to that of the others, must be that already described.

The inclination plane of rods on the peripheral propellers, between adjacent peripheral rollers (1), must be reversed (left-handed and right-handed).

The axial cylinders (3) of the rollers (1), are fixed into the same number of watertight ball bearings (14), set in supports (10-11), which are situated on the two ends of the atomization chamber (9).

The combs, in a less effective but easier to manufacture structure, may also be replaced by a fine mesh net with free saw-toothed edge, so that the apex of the peripheral roller teeth (1) corresponds with the bottom of the interdental spaces of the central roller (1).

Container Body (2)

This structure is made up of:

A atomization chamber (9).

This chamber (9) is made up of a cylinder in which, parallel to the axis of the cylinder, 6 cylindrical cavities of the same diameter have been carved, which are set up in the same way as the peripheral rollers (1) that we have already described, with a radius equal to the length of the rods (4) on the peripheral rollers (1) plus the radius of an axial cylinder (3) and the necessary distance to avoid contact with the rods (4). The centre of the “circle of reference” must correspond with the centre of the cylinder from which this chamber is made. As a result, one obtains a single cavity made up of six circled arches, which coincide with their side edges.

The input end of the chamber (9), by means of a windowed support (11), communicates with the transmission and input compartment (7). On the wall with coinciding arches, there are low and wide openings with an arched transversal cross-section, communicating with a ring-shaped collector (8). The top of this end of the chamber (9) is a closed support in the central part, in which seven ball-bearings (14) are set, through which the axes of the seven rollers (1) pass to enter the transmission and input compartment (7). Outside this area, there are ample openings that allow the fluid to enter the atomization chamber (9).

Transmission and input compartment (7).

In this compartment (7), on the axes of the six peripheral rollers (1), there are six gears, connected to one another. A seventh gear is placed on top of the gear on one of the peripheral rollers (1) and is joined, at a higher level, with a gear attached to the axis of the central roller (1) at the end of which is the transmission joint (15).

The gears (13) are protected by a sump (12) that allows the central transmission axis to pass through.

Input tubes (6) are inserted on the roof of this compartment, and there is a central watertight ball-bearing (14) for the transmission axis.

The opposite end of the atomization chamber (9) is open, although there is a support (10) “at rosette” here, holding the seven ball-bearings (14) in which the other ends of the axes of the seven rollers (1) are inserted. This support (10) is made to leave the largest possible surface open, even though it supplies the gains for the ball-bearings (14).

### Operation

A motor transmits the rotation to the rollers by means of the axis, the gear for the central roller and the six gears connected to one another.

The direction of rotation of the peripheral gears will, for adjacent rollers, be opposite.

In this way, if one roller turns in one direction (for example, anticlockwise), the two adjacent rollers will turn in the opposite direction (clockwise).

One of the fluids to be treated is inserted in the atomization chamber through the input tubes and the transmission and input compartment. The other (or the others) enters through the collector.

The two (or more) fluids meet in the atomization chamber.

The rollers, by turning, atomize (with the combs) the liquid fluid(s), which, by mixing with the gaseous fluid(s), forms a foamy mixture.

The pressure above (and/or the propeller-type conformation of the rods), drives the foam down, where the atomization/mixing process continues along the entire length of the atomization chamber.

When necessary, at the exit of the atomizer, a centrifugal separator will be inserted (like the one described in the request to PCT N^{o} PCT PCT/IT2004/000377), which will allow the gases to pass through, extracting the liquids from the foam. A second atomizer may be positioned after the separator and, in this way, more atomizers and separators in series.

The gas will cross through the transmission and input compartment and, on entering the next atomization chamber, will be mixed with other “new” liquid fluid.

The separation process can also take place in suitable decanter-tanks on exiting which the foam coming from one or more atomizer (in series) is treated by a single centrifugal separator, so that the liquid can fall back into the tank while the gas can escape out.

The operation of this apparatus is based:

1) On the fragmentation carried out by the rotating rods.

2) On the persistence of the process of fragmentation and agitation that avoids the re-aggregation of the micro-fragments and facilitates the renovation of the contact interfaces between different fluids.

3) On the neutralisation, attenuation and deviation of the centrifugal vectors generated by the rotation transmitted to the particles: this results in the lack in the chamber of an area of low density atomized liquid.

4) On the fact that the fluid mixture, atomized and mixed, moves along the chamber continuing to be atomized and mixed.

Concerning Point 1:

The fragmentation depends on the disaggregating action owed to the impact of the rods on a fluid mass.

This action is more intense the greater the mass of the struck body, and therefore the resistance to the impulsive force. The brusque increase in pressure in the fluid generates the disintegration of the (liquid) fluid and, in the presence of gases, allows for the formation of a foam, the density of which will depend on the liquid-gas quantity correlations and on the surface tension of the liquid;

Furthermore, the fragmentation increases as the angular-velocity of the rotation of the rollers increases.

Thinner rods have a greater penetrating capacity.

Larger rods allow for the application of impacting force to a larger surface area of fluid, and therefore a greater explosive effect.

By placing the thin rods close to each other, one simultaneously obtains a compressive and slashing action.

Concerning Point 2

After the disintegration of the liquid, which practically takes place immediately, this state is maintained by the action of the rods along the entire atomization chamber.

Concerning Point 3:

The particular layout of the rollers and of the “combs” means that the centrifugal vector of the central roller and partially that of the peripheral rollers, is neutralised or deviated by the vector of the adjacent rollers. This prevents the fluid with the greatest density (liquid) from accumulating on the outer sides of the atomization chamber, leaving the central area to the fluid with the least density (gas).

The only areas in which there is a lack of contrast with the centrifugal vector are the external segments of the peripheral circular areas.

In this area (critical area, see FIG. 8), there is, anyway, a continuous flow from the centre of the roller towards the outside, which ensures the presence of atomized fluid even in this area (the possibility of eliminating this imperfection is explored further on); furthermore, the presence of disks in the peripheral rollers, preventing the passage through the outer areas of the axial cylinders, prevents the fluid with least density (gas) from passing through the external segments with a low concentration of atomized fluid.

In the central roller, the disks serve the purpose of preventing the fluid from passing through the areas that the rods of the peripheral rollers cannot reach. The layout and particular direction of rotation mean that a single peripheral roller, on one side, creates with the adjacent roller a rotary drive that leads the fragmented fluid towards the central roller, on the other side, with the other adjacent roller, it generates a rotary drive that tends to lead the fluid outwards. In this way in the 6 spaces between the peripheral rollers, a centrifugal flow (3 spaces) and a centripetal flow (3 spaces) are created alternatively, considering the centre to be the centre of the chamber.

This prevents the formation of empty areas. (See FIG. 8).

Concerning Point 4:

The fluids are driven along the chamber by the pressure generated by their own insertion.

As we have already mentioned, if necessary, by using laminar rods it is possible to create superimposed propellers, so as to obtain an axial pump with multiple propellers.

The result of this process is an intense and fine mixture of two or more fluids, which, if one is gaseous, becomes a dense foam.

The contact surface between the liquid(s) and the gas(es) is, thanks to this procedure, broadened enormously.

This makes it possible to obtain, in an extremely limited amount of time, contact between an enormous number of molecules of the various fluids (gaseous and liquid, in solution or liquid dispersion).

This phenomenon may be used for various purposes:

1) To obtain, rapidly and for large quantities of reagents, the reaction of one (or more) gas with reagents dissolved in a liquid medium or forming the liquid itself.

The reaction may in some cases be spontaneous (e.g.: CO2+Ca(OH)²), and in others may continue after having been set off (fuel+O2).

2) To allow for the capture of particles dispersed in gases (unburnt residues, dusts) by a atomized liquid.

3) To obtain a heat exchange between a liquid and a gas.

4) The rapid and continuous mixing of fluids can be useful in various sectors: Production, transformation, laboratory processes, etc.

The advantages of the atomizer mixer according to the invention, compared to those currently in use, are:

a) The possibility of obtaining a atomized mixing column as long as one wishes.

b) The mixture can run very quickly and at the same time, the molecules of one fluid can come into contact with those of another.

c) The procedure can be carried out in continuous flow.

d) The micro-aggregates cannot cohere in larger aggregates: They are continuously destroyed and reformed.

e) This system does not require injectors that can become clogged, nor the compression of the liquid.

The energy necessary to rotate the rollers is relatively limited, since the viscosity of the atomized fluid is very low (in the presence of a gas).

### DESCRIPTION OF THE DRAWINGS

FIG. 1

View of a longitudinal cross-section of the atomizer according to the invention.

FIG. 2

Oblique axonometric projection of a longitudinal cross-section of the atomizer, according to the invention, without the rollers, the sump and with the semi-cross section of the transmission and input compartment.

FIG. 3

Oblique axonometric projection of a longitudinal cross-section of the atomizer according to the invention, with the rollers.

FIG. 4

View from above of a transversal cross-section of the atomizer according to the invention: the support at rosette has been removed.

FIG. 5

Oblique axonometric projection of a slice of the atomizer chamber, obtained by means of two transversal cross-sections.

FIG. 6

View of a longitudinal cross-section of the rollers.

FIG. 7

View of a slice of the atomization chamber obtained from a model of the atomizer according to the invention with the wall of the container body finned (one of the three parts of the wall has been removed, another has been moved, and only two rollers are shown).

FIG. 9

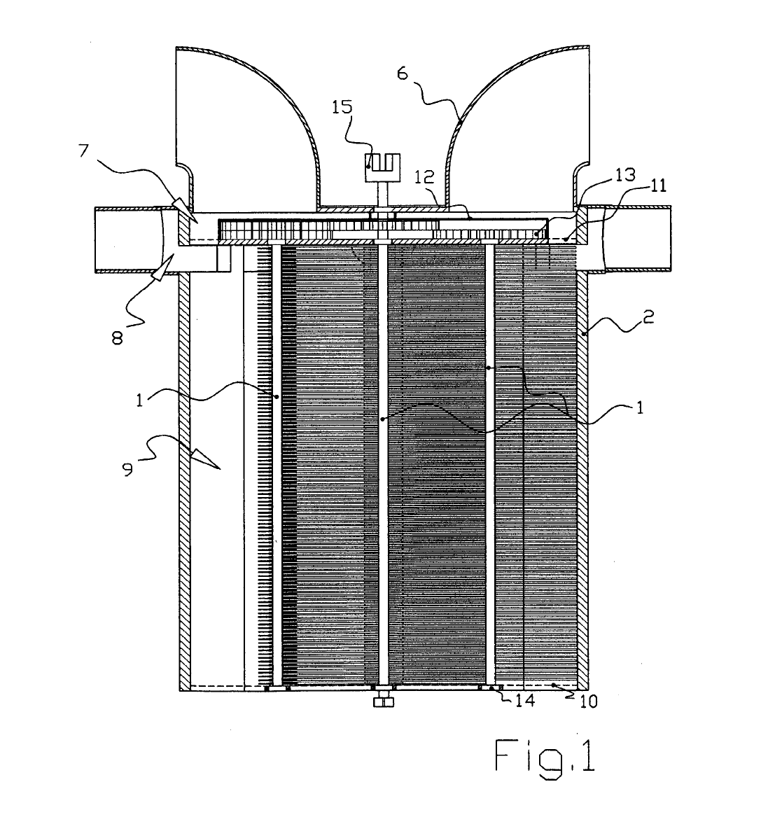

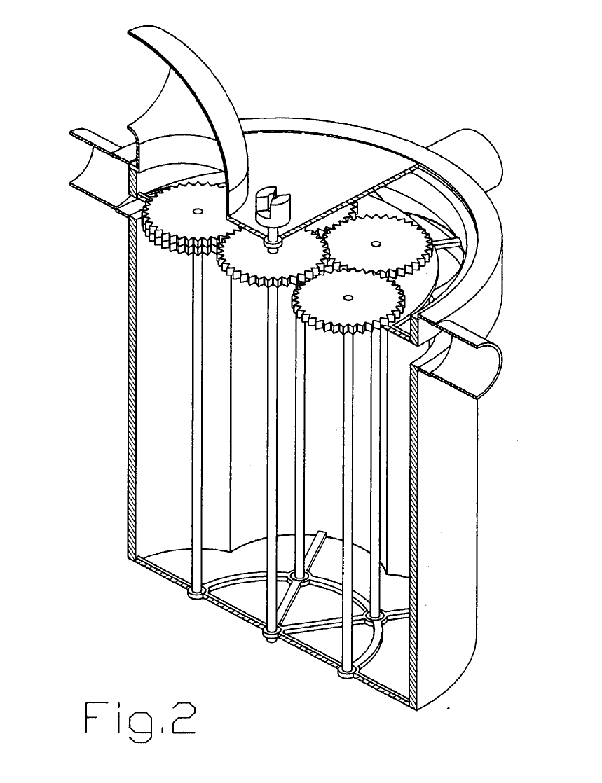

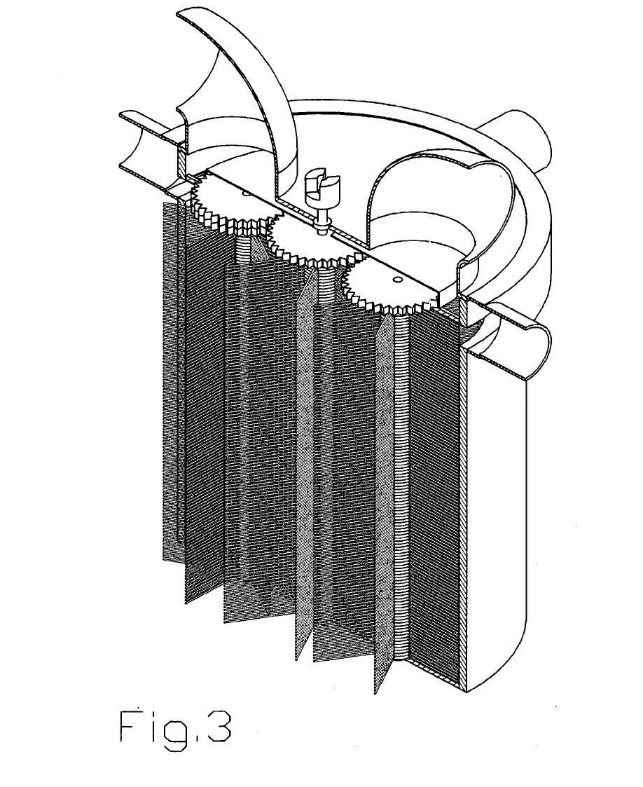

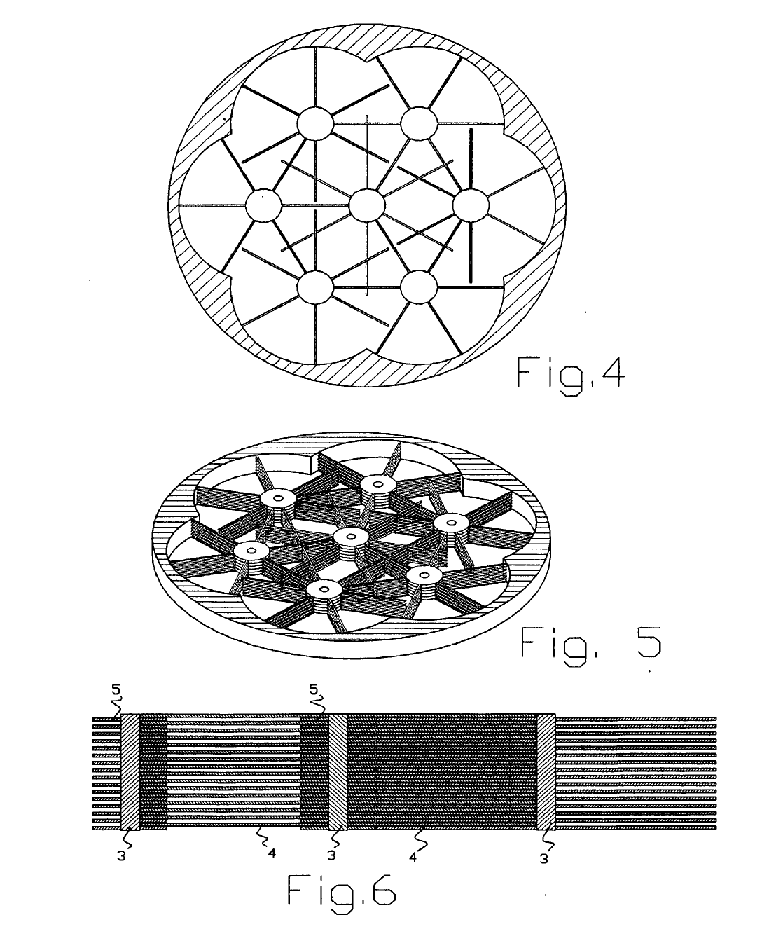

Layout of the atomizer according to the invention with the wall of the atomization chamber at coinciding arches with semi-elliptical shape and the elastic rods.

FIGS. 8, 10 and 11.

Layout of the atomizer according to the invention, with one or more functional units (each roller corresponds with a circle):

With one functional unit (7 rollers), the critical area is indicated (Z. Cr.), FIG. 8; with 7 functional units, FIG. 10; with 19 functional units, FIG. 11.

### THE BEST WAY TO ACTUATE THE INVENTION

In order to suitably dimension the cross-section of the atomization chamber also considering the radius of the circular surface area occupied by a single roller, it is necessary to consider the correlation existing between the surface area (open) of the total cross section (Atot.) and the radius (r) of the cross-section occupied by a single roller (axial cylinder and combs). This correlation is expressed by the following equation:

Atot.=r²π+6{2*[r²π/6−0.5r*√(r²−(0.5r)²)]+3(r²π/6−2*[r²π/6−0.5r*√(r²−(0.5r)²)]}.

Furthermore, one must also add the surface area occupied by the axes, by the disks and by the rods.

If one wishes to achieve the optimum performance level from this machine, it is necessary to consider the fact that, along the atomization chamber, there is a progressive depletion in the active component (a component that could be chemical, e.g.: Ca (OH)² or physical, e.g.: thermal energy) and therefore a greater number of contacts, between the fluids that one wishes to interact, becomes useless.

The assembly in modules set up in series, alternated with the same number of centrifugal separators, makes it possible to make the fluid to be modified (chemically or physically) interact with the fluid that possesses the modifying component (liquid to capture the particles, thermal energy, chemical components, etc.), so that the “modifying” fluid or the fluid “to be modified” is new in each module.

The modifying fluid can exit the atomizer after having passed its modifying component on (e.g.: hot air that has given its thermal energy to water), in this case, modified liquid comes out of the centrifugal separators. Vice versa, the modifying fluid can enter each module again and come out through the centrifugal separator, allowing the modified fluid to enter the following module (for example: cold water that subtracts thermal energy from the air, entering each module cold and exiting each module hotter).

Another type of modular assembly is in the parallel layout.

This layout makes it possible to not use a centrifugal separator at the exit of each atomizer, but instead to only use one: either situated at the end of the collector tube that collects the fluid from all the atomizers, or installed above, at the exit from the decanting tank.

With this type of assembly, since it is possible to divide the fluids into a number of atomizers, one obtains a reduction in the flow velocity and therefore a longer mixing process.

The problem with the area of rarefaction of the atomized fluid (an area in the external slice of the peripheral rollers) appears particularly in the case of chambers with a particularly extensive cross-section and when one wishes to guarantee the interaction of the fluids almost absolutely.

In order to eliminate this problem, already amply solved by the presence of the disks, one can:

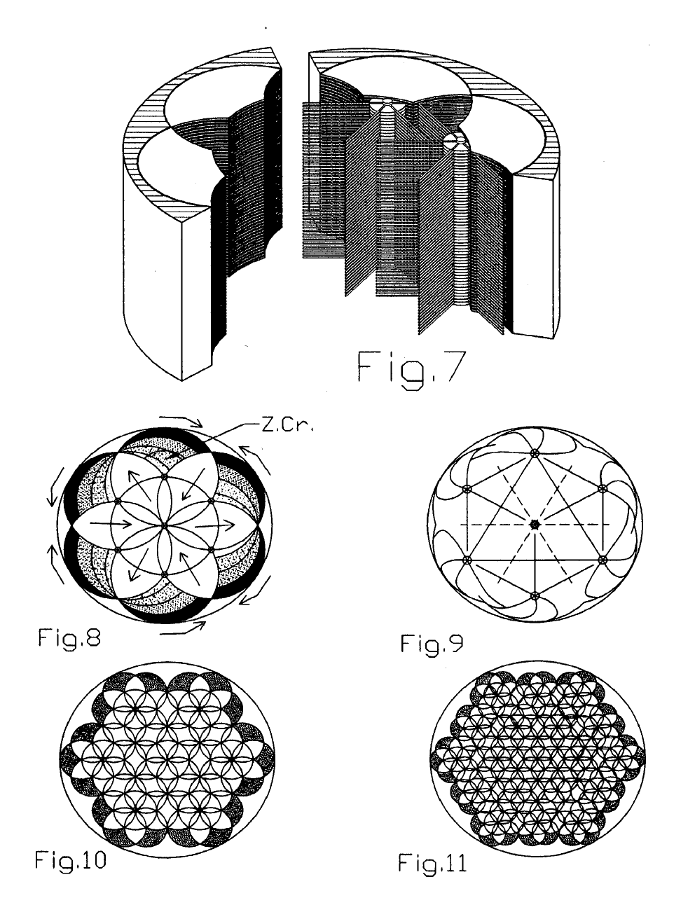

1) Prevent the passage of gas through the critical areas (the external segment of the peripheral rollers), by equipping the arched wall of the atomization chamber with diaphragm-fins, which selectively close these spaces, inserted between the planes corresponding with the rods of comb. In this case, if one uses rigid rods, the wall must be divided longitudinally into three parts and must be assembled after the rollers have been assembled (see FIG. 7).

2) Flatten the arches in the atomization chamber walls (creating a semi-elliptic arch with the smaller axis towards the centre of the chamber). In this case, one must use elastic rods for the combs (see FIG. 9).

3) Considering the group of 7 rollers as a functional unit, one can use a higher number (increasing by multiples of 6) of subsets of rollers (from which one subtracts a roller in the places where two coincide). In this way one creates a central area in which the absence of areas of rarefaction is guaranteed, with a peripheral area that has very small areas of rarefaction which, added together, have an overall surface area that is much smaller than the one that is encountered in a chamber with the same surface area but a lower number of functional units. (See FIGS. 10 and 11)

### INDUSTRIAL APPLICABILITY.

The atomizer-mixer subject to this request can be used for many applications:

1) To mix one or more liquids with: a gas or a gaseous mixture, smoke, mists, or dusts.

This procedure can be useful for:

a) Purifying continuous streams of smoke, mists or gases of various origins; (combustion of substrata to obtain thermal energy, electrical energy, mechanical energy; productive processes, transformation processes; destruction of waste; fires; tobacco smoke).

For example:

One can mix a smoke containing a pollutant gas (e.g.: CO2) with water containing suitable quantities of a solute (e.g.: Ca (OH)²) which can, reacting with the gas and forming a non-gaseous substance (e.g.: CaCO³), retain it in a solution (and/or suspension) and therefore remove it from the gaseous phase. At the same time, the water (or, if necessary, another liquid), thanks to its electric charge on the surface, will retain solid and/or dispersed liquid particles (e.g.: unburnt hydrocarbons). By removing this liquid (by means of the centrifugal separator subject to PCT request n^{o} PCT/IT2004/000377), one will obtain the elimination of the pollutant components, captured by means of the liquid, from the gaseous flow.

b) Purification of dusts in continuous flow

For example: The elimination of dusts in industrial processes or in cleaning (vacuum cleaner).

c) To facilitate the mixture of air and fuel for combustion.

For example: Boiler burners, internal combustion engines.

d) To obtain a thermal exchange between a liquid and a gas.

For example, heat extraction from boiler, heaters, fireplaces, gaseous discharges or hot liquids; cooling air (air conditioning units).

e) To obtain: foams, oxygenation of fish tanks, swimming pools, etc.

f) To obtain pulverisation—mixing process in industrial or laboratory procedures.

2) To mix two or more liquids rapidly and in continuous flow (preferably in the presence of gas in order to reduce the viscosity).

3) To mix one or more gases rapidly and in continuous flow.

1. According to the invention, the atomizer-mixer has the following capability:
The fluid atomization is continuous. It is not caused by an only expulsive event of the fluid, but by numerous events of percussion and fragmentation of fluid, continuously and with high-frequency, along a atomization, chamber.
Thanks to peculiar position of a precise number of atomizer rolls rotating on their axes, around a central atomizer roll also rotating on its axis, there are no or are rather small the areas in which the liquid fluid, at a higher density, can accumulate on the border of the rolls.
In this manner the circular area, near the roller axis, would be left to the gas fluid at a lower density which, in that case, would not interact whit the liquid fluid.

2. According to the invention, the atomizer is characterised by the fact that, in its basic form, it mainly includes:
A) A container body (2).
B) Seven atomizer_rolls (1) placed parallel to one another.
They are held in a atomization chamber (9) at confluent vaults drawn from the container body and they are placed parallel to its longitudinal ideal axis.

3. According to the invention, the atomizer is characterised by the fact that:
Ones of the seven rollers is central while the other six ones are placed around the first one.

4. According to the inventions the atomizer is characterised by the fact that:
The distances between the axis-centre of the seven rollers are equal and thus, one is at the centre while the other ones are at the tops of an ideal hexagon placed crosswise to their axes.

5. According to the invention, the atomizer is characterised by the fact that:
The rollers are made up of cylinders on the surface of which there are 6 combs placed like a star, that form six 60° angles on the transversal plane.

6. According to the invention, the atomizer is characterised by the fact that:
Thanks to the equal distance between the rollers, the free margin of the combs of every peripheral cylinder borders the axial cylinder of all adjacent rollers.

7. According to the invention, the atomizer is characterised by the fact that:
Two combs of every peripheral roller are articulated with the two adjacent peripheral rollers deeply entering the centre of the angle created by 2 combs of every one of the 2 rollers adjacent to the first one.

8. According to the invention, the atomizer is characterised by the fact that:
The combs are made up of rigid rods (4) that alternate lengthwise at spaces superior to their thickness enough to allow a similarly thick rod to pass without touching. To better fragment the fluid they will have, on the upper and lower surfaces, they are serrated with cuts perpendicular to their longitudinal axis.
The transversal section area of the rods must be as small as possible and anyway to the extend that the density and state of atomization of the liquid fluid will allow it.
In addition to the rods (4), for each group of coplanar rods (4), there is a disk (5) on the rollers.

9. According to the invention, the atomizer is characterised by the fact that:
On the six peripheral rollers,, the length of the rods (4) must be equal to the least distance between the external margins of the coplanar transversal sections of the adjacent axial cylinders (3) and enough to avoid that the coplanar rods (4) of the adjacent peripheral rollers (1) touch when rotating.
The disk (5) on the axial cylinder (3) occupies the remaining space between the rods (4) and the adjacent axial cylinder (3).
The disks (5) on the peripheral rollers (1) are on the same plane as the rods (4); their thickness is not superior to that of the rods.

10. According to the invention, the atomizer is characterised by the fact that:
On the central roller (1), the rods (4) and the disks (5) alternate lengthwise, the length of the rods (4) corresponds to the distance between the axial centre of the rollers (1) less the diameter of an axial cylinder (3).
This roller (1) too has six combs; the distance between the rods (4) is the same as that of the peripheral rollers (1).
The rods (4) of the peripheral rollers (1) must be able to pass closely between those of the central roller (1) and border the disks (5). Vice versa, the rods (4) of the central roller (1) must pass closely between the rods (4) and the disks (5) of the peripheral rollers (1), bordering their axial cylinders (3).
The rods (4) of the central roller (1) correspond to the spaces between the rods (4) of the peripheral rollers (1); its disks (5), alternated with its rods, are at the same level as the rods (4) and disks (5) of the peripheral rollers (1) (see FIG. 6).

11. According to the invention, the atomizer is characterised by the fact that:
The combs, in a less effective but more economic structure, can be replaced by a fine mesh with free saw-toothed edge, so that the point of teeth of the peripheral rollers correspond with the bottom of the interdental spaces of the central roller and vice versa.

12. According to the invention, the atomizer is characterised by the fact that:
The rods (4) can also be made using an elastic material, thus becoming straight but flexible.
It allows them to be flexible in case one wishes to flatten the arches of chamber (9) to reduce at a minimum the low-concentration area external to the peripheral rollers (1) (see FIG. 9).
Moreover, in case of elastic rods, there may be a greater number of rollers' combs (central and peripheral), though leading to a wearing friction between the rods (4).

13. According to the invention, the atomizer is characterised by the fact that:
The rods (4) can also be laminated, flattened and rotated suitably on their longitudinal axis in such a way as to form axial rotors that not only fragment and mix the fluid but also drive it.

14. According to the invention, the atomizer is characterised by the fact that:
When leaving unchanged the free section area of the atomization chamber (9), it is possible to increase the number of rollers (1), adding, by multiples of six, the functional units of the seven rollers (1), less one roller where two coincides; and thus, 6 rollers per every additional functional unit. (See FIG. 10 with 6 functional units in addition to the central one and FIG. 11 with additional 12 other functional units).
In this way, it is possible:
To increase the transmission ratio between the motor gear and that of the rollers, thus multiplying the rotation frequency of the rollers.
To reduce the percentage of section with a low density of nebulized fluid.

15. According to the invention, the atomizer is characterised by the fact that:
It is possible to increase the number of functional units, leaving unchanged the radius of the rollers, making the section area larger.
In this way, one can obtain, with the same length of the atomization chamber, a proportional increase in the capacity and thus of the volume of fluids treated in the time unit, or, on the contrary, maintain unchanged the capacity, proportionally reducing the length of the atomization chamber and increasing the section area.

16. According to the invention, the atomizer is characterised by the fact that:
The afore-mentioned container body (2) is made up of:
Atomization Chamber (9)
Transmission and input compartment (7).
Collector (8)

17. According to the invention,, the atomizer is characterised by the fact that the aforementioned atomization chamber (9) is realised as follows:
It is a cavity whose external walls form six circled arches, which coincide with their side edges (see FIGS. 4 and 5). The six arches come from six circles whose centre coincides with the vertexes of a regular hexagon inscribed in a circle. (“reference circle”) whose radius depends on the capacity desired.
The measure of the radius of the “reference circle”(or of the hexagon inscribed) depends on the section area that must allow for the fluid mixture to pass and that, in case one does not wish to modify the volumes, must correspond to the sum of the input pipes' sections of the 2 or more fluids to the atomizer.
After passing through the input collector (8), one of the fluids enters the chamber (9), thanks to the radial set openings.
Its down extremity is formed of a support (10)” at rosette” that though allowing the fluid to pass, presents the gains for the seven ball bearings in which the extremity of the seven rollers (1) is inserted.
Situated at the input end of the atomization chamber (9), the transmission and input compartment (7) communicates with this chamber (9) by means of windowed support (11) openings, wide enough for the fluid mixture's. flow. The centre of the twelve peripheral ball bearings (14), of which six are located in the windowed support and six in the support “at rosette”, is on axis with the vertexes of the hexagon inscribed in the “reference circle”.

18. According to the invention, the atomizer is characterised by the fact that:
To optimise the output, the walls of the chamber (9) can be equipped with particular diaphragm-fins, which are transversally inserted between the rods (4) of the peripheral rollers (1) in their external segment (see FIG. 7); or, when using elastic material for the rods (4), instead of being circled, the arches could be flattened (semi-elliptic arch) with the smaller axis towards the centre of the chamber (see FIG. 9).

19. According to the invention, the atomizer is characterised by the fact that: the afore-mentioned transmission and input compartment (7) is realised in the following way:
It contains the gears (13) that, inserted on the axes of the rollers (1), transmit the movement.
The six peripheral gears (13) are connected to one another. In this way, the direction of rotation of every peripheral roller (1) is opposite to that of the two adjacent peripheral rollers (1).
A seventh gear placed on top of one of the previous six ones is joined with a gear (13) attached to the axis of the central roller (1) through witch the transmission is transmitted.
Such central gear (13) receives its driving force by means of a transmission joint (15) from the motor in case of a single chamber (9) and from the central axis of the above module, in case of a module subsequent to the first one.
Since the rods of the central roller combs are in a plane, among that of the peripheral rollers' rods, there is no contact between the central roller and the peripheral rollers.
At the top a sump (12) protects the gears while, at the bottom the compartment (7) is limited by a windowed support (11) in which bearings are set (14). This support (11),closes the sump (12) and presents, on its borders, wide openings for the passage of the fluid to the atomization chamber (9). On its bottom wall, the compartment (7) presents input tubes (6) and, at its centre, a bearing (14) for the transmission.

20. According to the invention, the atomizer is characterised by the fact that: all rollers are equipped with active movement in relation to the fluid to be treated.

21. According to the invention, the atomizer is characterised by the fact that:
It is possible to use several atomizers, alternating the atomizers with centrifugal separators as the one described in the request to PCT/IT2004/000377, by connecting 2 or more in series so that every atomizer, followed by a centrifugal separator, necessary for eliminating the modifying fluid used, the following atomizer in which is renewed the modifying fluid, that must interact with the fluid to be treated.
